(19) United States
(12) Patent Application Publication
(10) Pub. No.: US 2024/0257312 A1
(43) Pub. Date: Aug. 1, 2024

(54) INFORMATION PROCESSING DEVICE, CONTROL METHOD FOR INFORMATION PROCESSING DEVICE, AND RECORDING MEDIUM

(71) Applicant: CANON KABUSHIKI KAISHA, Tokyo (JP)

(72) Inventor: YOSUKE TAKAGI, Kanagawa (JP)

(21) Appl. No.: 18/421,821

(22) Filed: Jan. 24, 2024

(30) Foreign Application Priority Data
Jan. 30, 2023 (JP) 2023-012106

(51) Int. Cl. G06T 5/50; G06V 40/16

(52) U.S. Cl. CPC G06T 5/50; G06V 40/161; G06V 40/172; G06T 2207/20132; G06T 2207/20221

(57) ABSTRACT

An information-processing device includes one or more memories and one or more processors in communication with the one or more memories that are configured to record still images, moving images, and information about the moving images in association with the still images on a recording medium sort the still images based on whether a predetermined condition is satisfied, select a still image according to a user instruction from among still images that are sorted out, in the sorting, as not satisfying the predetermined condition, obtain information about a moving image in association with a still image that is sorted out, in the sorting, as satisfying the predetermined condition and a moving image in association with the selected still image, obtain, based on the information, the moving images, and generate a single combined moving image by combining a plurality of the moving images.

### BACKGROUND OF THE DISCLOSURE

### Field of the Disclosure

The present disclosure relates to an information-processing device, a control method for the information-processing device, and a recording medium.

### Description of the Related Art

Some image capturing devices have a function of recording still images and recording moving images captured for a predetermined period of time before issuance of a still image recording start instruction and then connecting (combining) the moving images recorded for one day and recording the combined moving images as one moving image file. This moving image file is hereinafter referred to as a “digest moving image (combined moving image)”. In other words, the digest moving image is a short moving image obtained by summarizing and combining images captured for a predetermined period of time (e.g., for one day).

Japanese Patent Application Laid-Open No. 2015-95771 discusses an imaging device configured to combine moving images corresponding to still images in which a face that matches a preliminarily registered face image is present and to record the combined moving images so that a digest moving image focusing on a specific subject can be generated.

The imaging device discussed in Japanese Patent Application Laid-Open No. 2015-95771 generates the digest moving image including moving images corresponding to still images in which a specific subject is present during image capturing. In this configuration, for example, even when a user sorts the still images and deletes unwanted still images after image capturing, the moving images corresponding to the deleted still images are combined with the digest moving image and remain without being deleted.

In other words, even when desired still images are sorted out in the recorded still images and unwanted still images are deleted after image capturing, the digest moving image includes the moving images corresponding to the deleted still images, so that the unwanted still images remain without being deleted.

### SUMMARY OF THE DISCLOSURE

The present disclosure is directed to generating a digest moving image including moving images corresponding to still images that are sorted out after image capturing and are desired by a user, in a case where still images and moving images in association with the still images are recorded and the recorded moving images are combined to generate the digest moving image.

According to an aspect of the present disclosure, an information-processing device includes one or more memories, and one or more processors in communication with the one or more memories. The one or more processors and the one or more memories are configured to record still images, moving images, and information about the moving images in association with the still images on a recording medium sort the still images based on whether a predetermined condition is satisfied, select a still image according to a user instruction from among still images that are sorted out, in the sorting, as not satisfying the predetermined condition, obtain information about a moving image in association with a still image that is sorted out, in the sorting, as satisfying the predetermined condition and a moving image in association with the selected still image, obtain, based on the information, the moving image in association with the still image that is sorted out, in the sorting, as satisfying the predetermined condition and the moving image in association with the selected still image, and generate a single combined moving image by combining a plurality of the moving images in association with the still images. The plurality of moving images in association with the still images is captured within a predetermined period of time at least either before or after capturing of the still images.

According to another aspect of the present disclosure, a method for controlling an information-processing device includes recording still images, moving images, and information about the moving images in association with the still images on a recording medium, sorting the still images based on whether a predetermined condition is satisfied, selecting a still image according to a user instruction from among still images that are sorted out, in the sorting, as not satisfying the predetermined condition, obtaining, as first obtaining, information about a moving image in association with a still image that is sorted out, in the sorting, as satisfying the predetermined condition and a moving image in association with the selected still image, obtaining, as second obtaining, based on the information obtained in the first obtaining, the moving image in association with the still image that is sorted out, in the sorting, as satisfying the predetermined condition and the moving image in association with the selected still image, and generating a single combined moving image by combining a plurality of the moving images obtained in the second obtaining. The plurality of moving images is captured within a predetermined period of time at least either before or after capturing of the still images.

Further features of the present disclosure will become apparent from the following description of exemplary embodiments with reference to the attached drawings.

### BRIEF DESCRIPTION OF THE DRAWINGS

FIG. 1A is an explanatory view illustrating a configuration example of an image capturing device according to a first exemplary embodiment, and FIG. 1B is an explanatory diagram illustrating an operation of the image capturing device.

FIG. 2 is a block diagram illustrating a configuration example of the image capturing device according to the first exemplary embodiment.

FIG. 3 is an explanatory diagram illustrating configuration examples of the image capturing device and a personal computer (PC) that is an example of an information-processing device according to the first exemplary embodiment.

FIG. 4 is a block diagram illustrating a configuration example of the PC as an example of the information-processing device according to the first exemplary embodiment.

FIG. 5 is a flowchart illustrating details of automatic image capturing processing to be performed by the image capturing device.

FIGS. 6A to 6D are explanatory views each illustrating area division.

FIG. 7 is a flowchart illustrating details of sorting processing to be performed by the PC as an example of the information-processing device according to the first exemplary embodiment.

FIGS. 8A to 8D are explanatory diagrams illustrating recording of still image files and moving image files with file names different from those in the image capturing device on a hard disk of the PC.

FIG. 9 is a flowchart illustrating details of sorting processing in which the PC, which is an example of the information-processing device according to the first exemplary embodiment, sorts still images in which a specific person is present.

### DESCRIPTION OF THE EMBODIMENTS

Exemplary embodiments of the present disclosure will be described in detail below with reference to the accompanying drawings.

In the specification and the drawings, components including substantially the same functional configuration are denoted by the same reference numerals, and duplicate descriptions are omitted.

A first exemplary embodiment of the present disclosure will be described below. An image capturing device 101 is a digital camera that automatically captures images based on a predetermined condition. For example, the image capturing device 101 automatically captures images every predetermined time, or automatically captures images based on information about a subject (e.g., a face of a person present as a subject) detected by the image capturing device 101. The images recorded on the image capturing device 101 are automatically captured by the image capturing device 101, and thus the captured images may include many images that are not desired by a user. To accurately sort out the images desired by the user in the images recorded on the image capturing device 101, a personal computer (PC) 401, which is an example of an information-processing device according to a first exemplary embodiment, is exemplified as an external device for image sorting. Prior to description of the PC 401, which is an example of the information-processing device, the image capturing device 101 will be initially described.

### [Description of Configuration of Image Capturing Device 101]

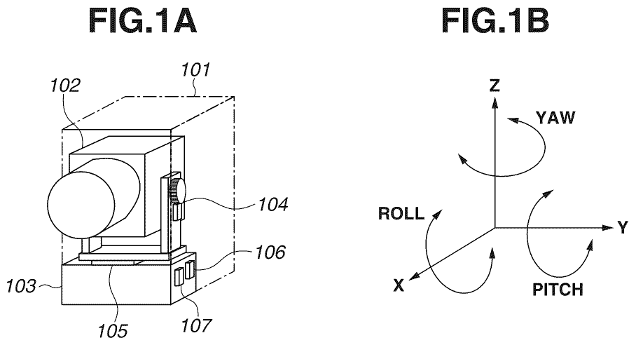

FIG. 1A schematically illustrates the image capturing device 101. The image capturing device 101 is provided with an operation member such as a switch for turning on or off a power supply. Examples of this operation member may include a button and a touch panel. For example, if a button is used as the operation member, the power supply can be turned on or off by pressing the button, and if a touch panel is used as the operation member, the power supply can be turned on or off by tapping, flicking, or swiping the touch panel.

A lens barrel 102 is a casing including an optical lens group and an image sensor, and is attached to the image capturing device 101. A tilt rotation unit 104 and a pan rotation unit 105 are rotation mechanisms configured to rotationally drive the lens barrel 102 with respect to a fixed portion 103. The tilt rotation unit 104 is a motor for driving the lens barrel 102 to rotate in a pitch direction illustrated in FIG. 1B. The pan rotation unit 105 is a motor for driving the lens barrel 102 to rotate in a yaw direction illustrated in FIG. 1B. The lens barrel 102 is rotatable in one or more axial directions by the tilt rotation unit 104 and the pan rotation unit 105. As illustrated in FIG. 1B, a rotation about a horizontal axis (X-axis) of the image capturing device 101 is defined as roll, a rotation about a vertical axis (Z-axis) of the image capturing device 101 is defined as yaw, and a rotation about an axis (Y-axis) in a depth direction (optical axis) is defined as pitch. A positive direction of the X-axis illustrated in FIG. 1B corresponds to the front side of the image capturing device 101.

An angular velocity meter 106 and an acceleration meter 107 are disposed on the fixed portion 103 of the image capturing device 101. The image capturing device 101 detects vibrations of the image capturing device 101 based on an angular velocity and an acceleration that are measured by the angular velocity meter 106 and the acceleration meter 107, respectively. The image capturing device 101 rotationally drives the tilt rotation unit 104 and the pan rotation unit 105 based on the detected vibrations, thus generating images with a shake or tilt in the lens barrel 102 corrected.

### [Description of Block Diagram Illustrating Configuration of Image Capturing Device 101]

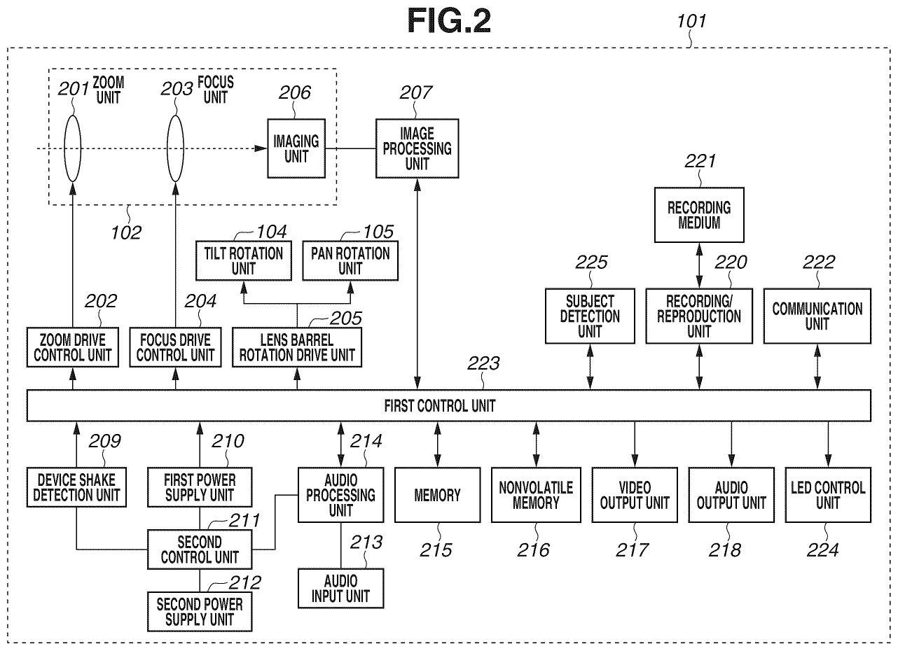

FIG. 2 is a block diagram illustrating a configuration example of the image capturing device 101 according to the first exemplary embodiment.

A first control unit 223 includes a processor (e.g., a central processing unit (CPU), a graphics processing unit (GPU), a micro processing unit (MPU)), and the like. The first control unit 223 includes a memory (e.g., a dynamic random access memory (DRAM), a static RAM (SRAM)), and the like. The first control unit 223 executes various processing to control the blocks of the image capturing device 101 and control data transfer between the blocks.

A nonvolatile memory 216 is a data recordable/erasable memory. Constants, programs, and the like for operation of the first control unit 223 are recorded on the nonvolatile memory 216.

A zoom unit 201 is an optical lens group constituting a zoom lens configured to change a zoom ratio. A zoom drive control unit 202 is a control unit that controls driving of the optical lens group of the zoom unit 201. A focus unit 203 is an optical lens group for focus adjustment.

A focus drive control unit 204 controls driving of the optical lens group of the focus unit 203. An imaging unit 206 receives light incident through each optical lens group on the image sensor, and outputs information about electric charges corresponding to the amount of the light as analog image data to an image processing unit 207. Here, the zoom unit 201, the zoom drive control unit 202, the focus unit 203, the focus drive control unit 204, and the imaging unit 206 are included in the lens barrel 102.

The image processing unit 207 converts the analog image data received from the imaging unit 206 into digital image data, performs image processing as described below, and outputs the digital image data. The digital image data is subjected to compression coding processing in accordance with compression coding standards, such as Joint Photographic Experts Group (JPEG) or Moving Picture Experts Group (MPEG), and the processed digital image data is stored in various image file formats, so that image files are generated. The image files are transmitted to a memory 215 and are temporarily recorded on the memory 215. In recording an image file temporarily recorded on the memory 215 on a recording medium 221, the first control unit 223 outputs the image file to a recording/reproduction unit 220, and the recording/reproduction unit 220 executes processing for recording the image file on the recording medium 221. In displaying and reproducing the image file, the first control unit 223 performs control to read out the image file from the memory 215 and output the image file to the image processing unit 207. The first control unit 223 controls the image processing unit 207 to execute image processing, such as decoding processing and color space conversion, on digital image data of the image file, and to output the digital image data to a video output unit 217.

A lens barrel rotation drive unit 205 drives the tilt rotation unit 104 and the pan rotation unit 105 to drive the lens barrel 102 in a tilt direction and a pan direction.

A device shake detection unit 209 is provided with, for example, the angular velocity meter 106 that detects angular velocities in three axial directions of the image capturing device 101 and the acceleration meter 107 that detects accelerations in three axial directions of the image capturing device 101. The device shake detection unit 209 calculates an angle of rotation, a shift amount, and the like of the image capturing device 101 based on signals detected by the angular velocity meter 106 and the acceleration meter 107.

An audio input unit 213 includes a plurality of microphones. The audio input unit 213 performs analog-to-digital (A/D) conversion processing on audio signals input from the microphones, and outputs the converted audio signals to an audio processing unit 214.

The audio processing unit 214 is configured to detect a sound direction on a plane on which the plurality of microphones is placed. The detected sound direction is useable for search and automatic image capturing to be described below. The audio processing unit 214 is also configured to recognize a specific audio command.

In the present exemplary embodiment, the specific audio command includes two types of words, specifically, a trigger word and a command word. The trigger word is a command used as a trigger to start recognition of the command word. Examples of the trigger word include a command including specific keywords such as “OK, camera” to be pronounced by the user.

The command word is used to instruct the image capturing device 101 to perform predetermined processing. Examples of the predetermined processing include still image capturing processing, moving image capturing start processing, moving capturing termination processing, sleep processing, subject change processing, and automatic image capturing processing. For example, the command word includes different keywords for each predetermined processing. Examples of the keywords include “capture a still image” in still image capturing processing, and “capture a moving image” in moving image capturing start processing.

Such audio commands are preliminarily recorded on the memory 215 in the image capturing device 101. In addition to these audio commands recorded in advance, the image capturing device 101 may be configured to register audio commands that are used for the user to execute certain processing.

The audio processing unit 214 performs audio-related processing, such as optimization processing and coding processing, on input audio signals. The first control unit 223 transmits the audio signals processed by the audio processing unit 214 to the memory 215.

The memory 215 temporarily records the digital image data input from the image processing unit 207 and the audio signals input from the audio processing unit 214. In recording the audio signals, the first control unit 223 outputs the audio signals from the memory 215 to the recording/reproduction unit 220.

The recording/reproduction unit 220 records the image data, audio signals, other pieces of control data for image capturing, and the like on the recording medium 221. The recording medium 221 may be a recording medium incorporated in the image capturing device 101, or may be a detachable recording medium.

In the present exemplary embodiment, the recording medium 221 has a capacity larger than that of the nonvolatile memory 216. Examples of the recording medium 221 include a hard disk, an optical disk, a magneto-optical disk, a compact disc (CD)-recordable (R), a digital versatile disc (DVD)-R, a magnetic tape, a nonvolatile semiconductor memory, and a flash memory.

The recording/reproduction unit 220 is configured to read out (reproduce) image data, audio signals, various data, and programs recorded on the recording medium 221. In reproducing the image data and audio signals recorded on the recording medium 221, the first control unit 223 operates as follows.

The first control unit 223 outputs image data and audio signals read out by the recording/reproduction unit 220 to the image processing unit 207 and the audio processing unit 214, respectively. The image processing unit 207 and the audio processing unit 214 decode the image data and the audio signals, respectively. The image processing unit 207 and the audio processing unit 214 output decoded signals to the video output unit 217 and an audio output unit 218, respectively.

A second control unit 211 controls power supply to the first control unit 223. For example, the second control unit 211 includes a processor (e.g., a CPU, a microprocessor, or an MPU), a memory (e.g., a DRAM or an SRAM), or the like. In the present exemplary embodiment, the second control unit 211 is provided separately from the first control unit 223 that controls an overall operation of a main system of the image capturing device 101.

A first power supply unit 210 and a second power supply unit 212 supply power for causing the first control unit 223 to operate and power for causing the second control unit 211 to operate, respectively. In the present exemplary embodiment, the power supplied from the first power supply unit 210 is larger than the power supplied from the second power supply unit 212, the first power supply unit 210 and the second power supply unit 212 are selected based on the amount of power to be supplied. For example, the first power supply unit 210 is a switch for supplying power to the first control unit 223, and the second power supply unit 212 is a battery such as an alkaline dry cell. When a power switch provided on the image capturing device 101 is pressed, power is first supplied to the second control unit 211 and then power is supplied to the first control unit 223.

The image capturing device 101 includes a sleep state. In the sleep state, the first control unit 223 controls the first power supply unit 210 to turn off power supply to the first control unit 223.

Even in the sleep state in which no power is supplied to the first control unit 223, the second control unit 211 operates and obtains information from the device shake detection unit 209 and the audio processing unit 214.

The second control unit 211 determines whether to start the first control unit 223 based on the input information. If the second control unit 211 determines to start the first control unit 223 (to cancel the sleep state), the second control unit 211 controls the first power supply unit 210 to supply power to the first control unit 223.

The audio output unit 218 outputs an audio signal corresponding to an electronic shutter sound or the like from a speaker incorporated in the image capturing device 101, for example, during image capturing. A light-emitting diode (LED) control unit 224 controls an LED provided on the image capturing device 101 to be turned on or blink in a preset pattern, for example, during image capturing.

The video output unit 217 includes, for example, a video output terminal, and outputs an image signal for causing a connected external display or the like to display a video image. The audio output unit 218 and the video output unit 217 may be configured as an interface, such as an integrated terminal, for example, a high-definition multimedia interface (HDMI®) terminal.

A communication unit 222 is an interface for establishing communication between the image capturing device 101 and an external device. The communication unit 222 is configured to, for example, transmit and receive audio signals and data such as image data. In response to the communication unit 222 receiving a control signal for image capturing processing, such as image capturing start, image capturing termination, pan driving, tilt driving, and zoom driving, the first control unit 223 drives the image capturing device 101 in response to the control signal.

The communication unit 222 includes a wireless communication module, such as an infrared communication module, a Bluetooth® communication module, a wireless local area network (LAN) communication module, a wireless universal serial bus (USB), or a global positioning system (GPS) receiver.

A subject detection unit 225 reads out image data output from the image processing unit 207 from the memory 215, and recognizes a subject, such as a person and an object. For example, in recognizing a person as a subject, the subject detection unit 225 detects the face of the person.

A pattern for determining the face of a person is preliminarily registered in the image capturing device 101. This pattern is provided with an identifier for distinguishing each subject. In the processing of detecting the face of a person present as a subject, the subject detection unit 225 detects an area that matches the pattern for determining the face of the person in an image to detect the face of the person. The subject detection unit 225 is configured to distinguish a plurality of registered faces from each other.

The subject detection unit 225 calculates a degree of reliability indicating a likelihood for the detected face of the person. The degree of reliability is calculated based on, for example, the size of a face area in the image, or the coincidence with a face pattern.

The subject detection unit 225 performs pattern matching on the face of the person in the image, thus detecting face information. The face information indicates whether the detected face is a smiling face, whether the eyes are wide open, and the orientation of the face among other types of information. The face information detection method is not limited to pattern matching. Known techniques, such as a method using deep learning, is applicable.

In object recognition processing, the subject detection unit 225 can recognize an object by determining whether an object area matches a preliminarily registered pattern. The subject detection unit 225 can also recognize an object by extracting a feature amount of a subject using a histogram of hue, color saturation, and the like in an image.

The subject detection unit 225 detects a subject to thereby obtain subject information. This subject information includes a subject identification result, information about the size of the face of a person present as a subject, face orientation information, the position of the subject within an angle of view, and a relationship between the position of the subject and a pan/tilt movable range.

### [Description of Configuration of Image Capturing Device 101 and PC 401]

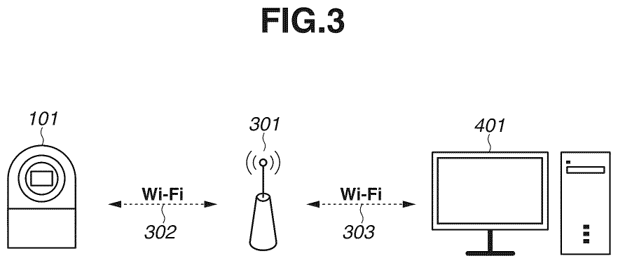

Configuration examples of the image capturing device 101 and the PC 401 will be described in detail with reference to FIG. 3. FIG. 3 is an explanatory diagram illustrating configuration examples of the image capturing device 101 and the PC 401 that is an example of the information-processing device according to the first exemplary embodiment.

The image capturing device 101 records an address of the PC 401. The image capturing device 101 and the PC 401 are connected via a network router 301. In this case, the network router 301 functions as a wireless LAN access point to construct a LAN. The image capturing device 101 functions as a wireless LAN client and joins the LAN constructed by the network router 301.

While the present exemplary embodiment illustrates an example where the image capturing device 101 is connected to the PC 401 via communication 302 and communication 303 (wireless LAN Wi-Fi®), the image capturing device 101 may be connected to the PC 401 via a wired connection, such as Ethernet.

### [Description of Configuration of PC 401]

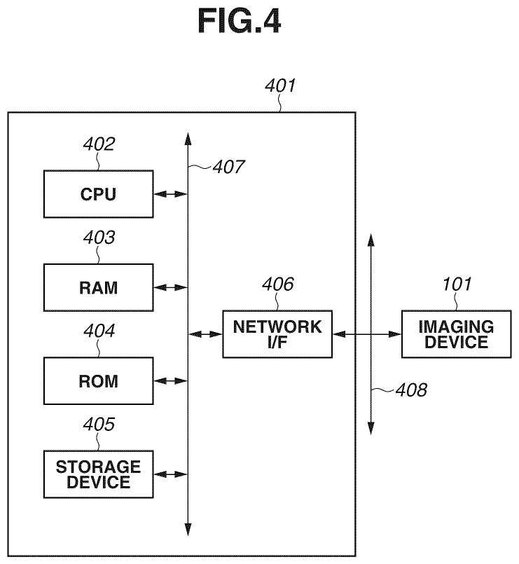

FIG. 4 is a block diagram illustrating a configuration example of the PC 401 that is an example of the information-processing device according to the first exemplary embodiment. The PC 401 includes a CPU 402, a RAM 403, a read-only memory (ROM) 404, a storage device 405, and a network interface (I/F) 406.

The CPU 402 executes programs recorded on the ROM 404, and programs such as an operating system (OS) and applications loaded into the RAM 403 from the storage device 405.

The RAM 403 is a main memory for the CPU 402, and functions as a work area or the like. The ROM 404 records various programs.

The storage device 405 records still image files and moving image files received from the image capturing device 101.

The network I/F 406 functions as an interface for connecting the image capturing device 101 to a network 408. The PC 401 and the image capturing device 101 are communicably connected via the network 408.

A system bus 407 is a communication circuit for establishing communication between hardware elements.

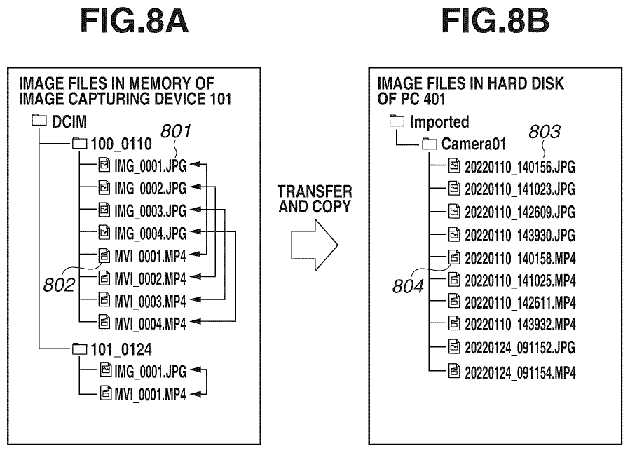

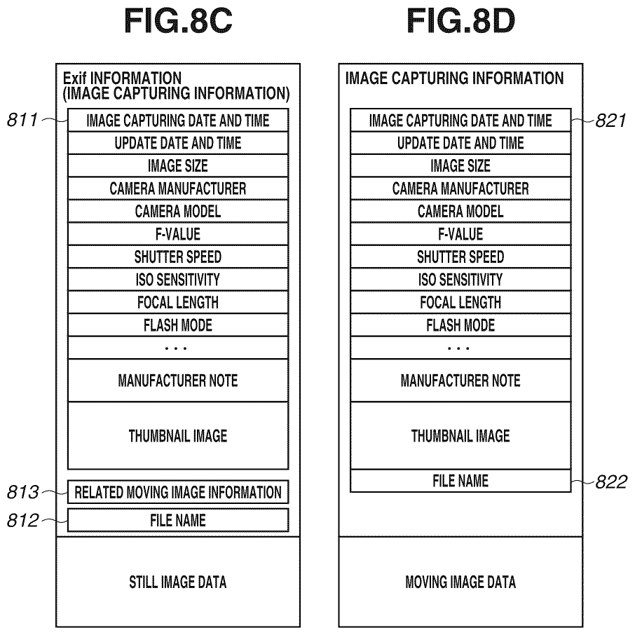

The CPU 402 of the PC 401 executes programs recorded on the ROM 404 to read out still image files and moving image files recorded on the storage device 405. As illustrated in FIGS. 8A to 8D, which will be described below, still image files and moving image files that are recorded on the storage device 405 of the PC 401 are obtained through transfer and copy of still image files and moving image files that are captured by the image capturing device 101 and are temporarily recorded on the memory 215.

### [Flowchart for Automatic Image Capturing Processing]

In the first exemplary embodiment, the image capturing device 101 is configured to capture images through automatic image capturing processing. The term “automatic image capturing processing” used herein refers to processing for determining a timing for the first control unit 223 to perform image capturing and automatically capturing images of a subject. In the automatic image capturing processing, the first control unit 223 recognizes a variation in expressions such as emotions of a specific subject or a person. If it is determined that a desired image is capturable, or after a certain period of time has elapsed, processing of determining a subject to be an automatic image capturing target and capturing an image of the subject is repeatedly performed. This processing enables the image capturing device 101 to capture an image of a desired scene that appears unexpectedly in a daily life, or an image of a subtle change in a daily life, without receiving any instruction input with a user's manual operation.

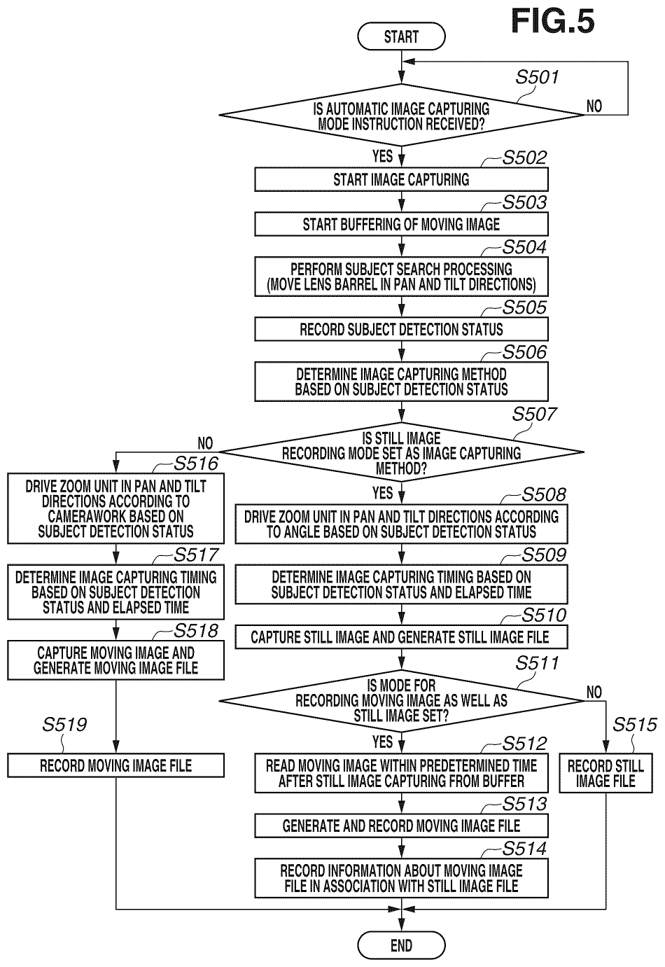

FIG. 5 is a flowchart illustrating details of automatic image capturing processing to be performed by the image capturing device 101. This processing is started when the image capturing device 101 is powered on, and is executed until the image capturing device 101 is powered off. In other words, this processing is repeated during a period in which the image capturing device 101 is powered on.

In the present exemplary embodiment, a wireless connection is established between the image capturing device 101 and a smart device. The user can perform various operations on the image capturing device 101 from a dedicated application on the smart device. The operation in each step of flowcharts to be described below is implemented by the communication unit 222 receiving an instruction from the dedicated application on the smart device and the first control unit 223 controlling each unit of the image capturing device 101 in response to the instruction. For example, if the user intends to move the orientation of the camera to follow the subject while viewing a video image on the dedicated application on the smart device, the communication unit 222 receives an instruction to move the orientation of the camera from the dedicated application. In response to this instruction, the first control unit 223 controls the lens barrel rotation drive unit 205 to move the lens barrel 102 in the pan direction and the tilt direction.

In step S501, the first control unit 223 determines whether an automatic image capturing mode instruction is received. If the first control unit 223 determines that the automatic image capturing mode instruction is received (YES in step S501), the processing proceeds to step S502. If the first control unit 223 determines that the automatic image capturing mode instruction is not received (NO in step S501), the first control unit 223 waits until the image capturing device 101 transitions to an automatic image capturing mode. In other words, if the first control unit 223 determines that the automatic image capturing mode instruction is not received (NO in step S501), the first control unit 223 repeatedly performs the operation in step S501 until the automatic image capturing mode instruction is received.

In step S502, the first control unit 223 starts to capture an image of a surrounding area of the image capturing device 101. Here, the first control unit 223 periodically obtains captured images, performs subject search processing as described below, and determines an imaging timing, an imaging direction, a zoom position, and a focus position for automatic image capturing.

In step S503, the first control unit 223 starts buffering of a moving image by storing the images obtained by image capturing in the memory 215. The memory 215 temporarily stores a latest moving image captured every predetermined time.

In step S504, the first control unit 223 controls the lens barrel rotation drive unit 205 to drive the tilt rotation unit 104 and the pan rotation unit 105 to move the lens barrel 102 in the pan direction and the tilt direction, thus automatically searching for the subject in the image obtained by image capturing. The subject search processing is performed in the following procedures (1) to (3).

### (1) Area Division

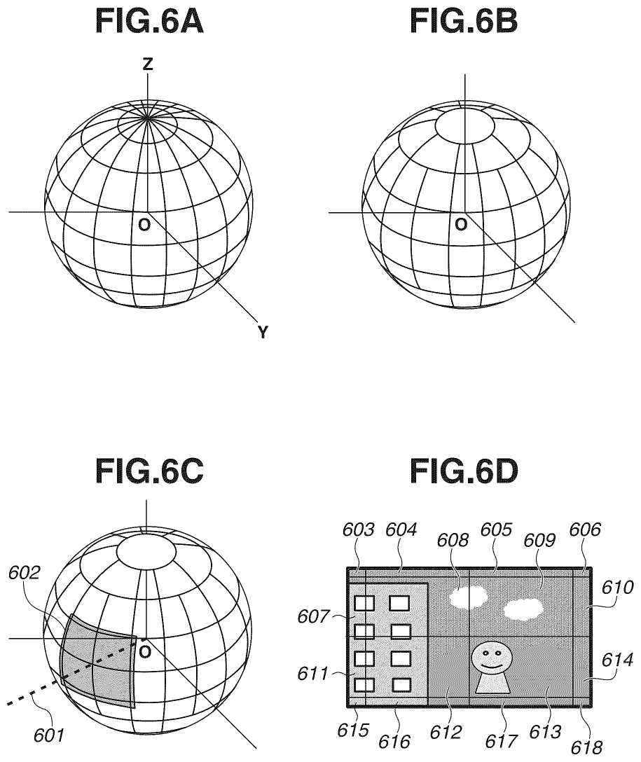

Area division will be described with reference to FIGS. 6A to 6D. As illustrated in FIGS. 6A to 6D, an area on a spherical surface on which the position of the image capturing device 101 set to an origin O is divided. In FIG. 6A, the area is divided every 22.5 degrees in a rotational direction (tilt direction) about the Y-axis and in a rotational direction (pan direction) about the Z-axis. If the area is divided as illustrated in FIG. 6A, the size of each area decreases in a direction away from the origin O in the positive and negative directions of the Z-axis. To calculate the importance level, reference areas with substantially the same size are to be set. Accordingly, the image capturing device 101 according to the present exemplary embodiment sets the area range in the positive and negative directions of the Y-axis to be larger than 22.5 degrees, if the angle formed between the Y-axis and the Z-axis is 45 degrees or more as illustrated in FIG. 6B.

Next, an area in the angle of view of an image captured by the image capturing device 101 will be described with reference to FIGS. 6C and 6D. An axis 601 serves as a reference direction for an imaging direction of the image capturing device 101, and area division is performed based on the reference direction. The axis 601 serves as, for example, the imaging direction when the image capturing device 101 is started, or a direction predetermined to be the reference direction for the imaging direction. An area 602 is an angle-of-view area of an image captured by the imaging unit 206. FIG. 6D illustrates an example of a live view image captured by the imaging unit 206 in the area 602. In the angle of view of the live view image illustrated in FIG. 6D, the area of the image is divided into areas 603 to 618 based on the area division illustrated in FIG. 6C.

### (2) Calculation of Importance Level for Each Area

For each divided area obtained as described above, the importance level indicating a priority level to be used in the subject search processing is calculated based on a status of a subject present in each area or a status of a scene in each area. The importance level based on the status of the subject is calculated based on, for example, the number of faces of persons present as the subject in the area, the size of each face, the orientation of each face, the likelihood for face detection, expressions on each face, an individual identification result based on each face, a motion of each person, and the like. The importance level based on the status of the scene is calculated based on, for example, a general object recognition result, a scene determination result (blue sky, backlight, evening scene, etc.), a volume of sound generated from the direction of each area, a voice recognition result, motion detection information about the subject in each area, and the like. Here, the first control unit 223 drives the image capturing device 101 to search all areas where image capturing is performable by the image capturing device 101, and calculates the importance level for each area.

For example, if the face of a specific person to be subjected to individual identification is registered in advance, the first control unit 223 sets the importance level for the area in which the registered face of the person is detected to a value higher than a standard value. For example, faces of persons are recorded as a pattern for determining the subject on the nonvolatile memory 216. In the case where the first control unit 223 sets the importance level for the area in which the face of a person is detected to a value higher than the standard value, the importance level for the area is reset to the standard value if a predetermined time has elapsed from the time of making the setting, or if image capturing has been performed a predetermined number of times from the time of making the setting.

### (3) Determination of Search Area

The first control unit 223 calculates the importance level for each area as described above, and then selects areas with a high importance level as image capturing candidate areas and determines to intensively perform search processing on the image capturing candidate areas. The first control unit 223 calculates a pan angle and a tilt angle to be used for capturing an image of one of the selected image capturing candidate areas.

In step S505, the first control unit 223 records on the memory 215 a subject detection status in the subject search processing in step S504 for the selected image capturing candidate areas. This subject detection status is information indicating the number of faces of persons present as the subject, the size of each face, the orientation of each face, the likelihood for face detection, expressions on each face, an individual identification result based on each face, a motion of each person, and the like, which are used in the calculation of the importance level.

In step S506, the first control unit 223 determines an image capturing method based on the subject detection status recorded in step S505. Examples of the image capturing method include a still image recording mode and a moving image recording mode. For example, if a small motion of a person as a subject is detected, the first control unit 223 sets the still image recording mode to the image capturing method, and if a large motion of a person as a subject is detected, the first control unit 223 sets the moving image recording mode to the image capturing method.

In step S507, the first control unit 223 determines whether the image capturing method determined in step S506 is the still image recording mode. If the first control unit 223 determines that the image capturing method is the still image recording mode (YES in step S507), the processing proceeds to step S508. If the first control unit 223 determines that the image capturing method is not the still image recording mode (NO in step S507), the processing proceeds to step S516.

In step S508, the first control unit 223 controls the lens barrel rotation drive unit 205 to drive the lens barrel 102 in the tilt direction and the pan direction according to the angle based on the subject detection status in the search area selected as the image capturing candidate area in step S504. Here, in following a moving subject, an image shake correction amount used for an image shake correction is calculated in advance, the lens barrel 102 is driven in the pan direction and the tilt direction based on the image shake correction amount. A method for calculating the image shake correction amount is as follows. The first control unit 223 calculates an absolute angle of the image capturing device 101 from the angular velocity and the acceleration obtained by the device shake detection unit 209, and also calculates an image stabilization angle (i.e., an image shake correction amount) for moving the tilt rotation unit 104 and the pan rotation unit 105 in the angle direction in which the absolute angle is cancelled out.

In step S508, the first control unit 223 controls the zoom drive control unit 202 to drive the optical lens group of the zoom unit 201 so that an image of the face of the person present as the subject is captured with an appropriate face size within the angle of view based on the subject detection status (in particular, the size of the face).

In step S509, the first control unit 223 determines an image capturing timing based on the subject detection status or the elapsed time after image capturing is started in step S502. For example, if a variation in expressions such as emotions of a person present as a subject, a person set by the user, and the like is detected, the first control unit 223 determines to perform image capturing. The first control unit 223 may determine to perform image capturing after a lapse of a predetermined time, without detecting a variation in expressions of a person, a specific person, and the like as described above.

In step S510, the first control unit 223 causes the imaging unit 206 to capture an image of a subject to obtain analog image data, and causes the image processing unit 207 to convert the analog image data output from the imaging unit 206 into digital image data and to execute image processing on the digital image data. The first control unit 223 causes the image processing unit 207 to perform compression coding processing on the digital image data in accordance with the compression coding standard of JPEG, thus generating a still image file of JPEG format. Examples of the image processing to be executed on the digital image data by the image processing unit 207 include the following processing: sensor correction processing; demosaicing processing; pixel interpolation; color correction (white balance, color matrix conversion, gamma conversion); and red, green, and blue (RGB) signal processing (sharpness correction, tone correction, exposure correction, image combining, etc.). Instead of generating the still image file of JPEG format, a still image file of RAW format may be generated based on digital image data (RAW data) on which image processing is not executed.

In step S511, the first control unit 223 determines whether a mode for recording a moving image as well as a still image is set. If the first control unit 223 determines that the mode for recording a moving image as well as a still image is not set (NO in step S511), the processing proceeds to step S515. In step S515, the first control unit 223 causes the recording/reproduction unit 220 to record the still image file of JPEG format on the recording medium 221, and then the processing is ended. If the first control unit 223 determines that the mode for recording a moving image as well as a still image is set (YES in step S511), the processing proceeds to step S512.

In step S512, the first control unit 223 reads out a moving image within a predetermined time after still image capturing from a buffer. The moving image may be one captured for a several seconds before still image capturing, or may be one captured for several seconds after still image capturing. In other words, a moving image captured within a predetermined time before or after recording of a still image, or a moving image captured within a predetermined time before and after recording of a still image may be used. The moving image includes a plurality of temporally successive pieces of digital image data.

In step S513, the first control unit 223 causes the image processing unit 207 to perform compression coding processing on the moving image read out in step S512 to generate a moving image file of MPEG format, and to record the generated moving image file on the recording medium 221.

In step S514, the first control unit 223 performs control to record the still image file generated in step S510 in association with information related to the moving image file (related moving image information), and then the processing is ended. The related moving image information may include information for uniquely identifying a moving image file. Examples of the information include a file name, an identification (ID), and/or a timestamp.

In step S516, the first control unit 223 controls the lens barrel rotation drive unit 205 to drive the lens barrel 102 in the tilt direction and the pan direction according to the angle based on the subject detection status in the search area selected as the image capturing candidate area in step S504. In the case of following a moving subject, the image shake correction amount for correcting an image shake is calculated in advance, and the lens barrel 102 is driven in the pan direction and the tilt direction based on the image shake correction amount. The method for calculating the image shake correction amount has been described above.

In step S516, the first control unit 223 controls the zoom drive control unit 202 to drive the optical lens group of the zoom unit 201 so that the image of the face of the person present as the subject is captured with an appropriate face size within the angle of view based on the subject detection status (in particular, the size of the face).

In step S517, the first control unit 223 determines the image capturing timing based on the subject detection status and/or the elapsed time from image capturing is started in step S502. For example, if the magnitude of motion of a person as a subject, or a scene, such as a sports event or a school play, is detected, the first control unit 223 determines to perform image capturing. The first control unit 223 may determine to perform image capturing after a lapse of a predetermined time, without detection of the magnitude of a motion of a person, a specific scene, or the like as described above.

In step S518, the first control unit 223 captures a moving image while controlling the lens barrel rotation drive unit 205 to drive the lens barrel 102 in the pan direction and the tilt direction and also controlling the zoom drive control unit 202 to drive the optical lens group of the zoom unit 201. The image processing unit 207 converts the analog image data output from the imaging unit 206 into digital image data, and executes image processing on the digital image data. The first control unit 223 causes the image processing unit 207 to perform compression coding processing on a plurality of temporally successive pieces of digital image data according to the compression coding standard of MPEG, thereby generating a moving image file of MPEG format. The plurality of temporally successive pieces of digital image data corresponds to frame images constituting a moving image.

In step S519, the first control unit 223 records the moving image file of MPEG format generated in step S518 on the recording medium 221, and then the processing is ended.

In the flowchart illustrated in FIG. 5, after buffering of the moving image is started in step S503, still image capturing is performed in step S510. Even after the still image capturing, buffering of the moving image is continued and imaging processing is performed while the tilt rotation unit 104 and the pan rotation unit 105 are prevented from being rotationally driven by an amount more than a predetermined amount within a predetermined time after still image capturing. The moving image obtained in the imaging processing as described above may be buffered. The related moving image information about the moving image buffered within the predetermined time after still image capturing is recorded in association with the still image file generated in the still image capturing.

The first control unit 223 of the image capturing device 101 reads out the still image file and the moving image file from the recording medium 221, and controls the communication unit 222 to transmit the still image file and the moving image file to the PC 401.

### [Flowchart for Sorting Processing]

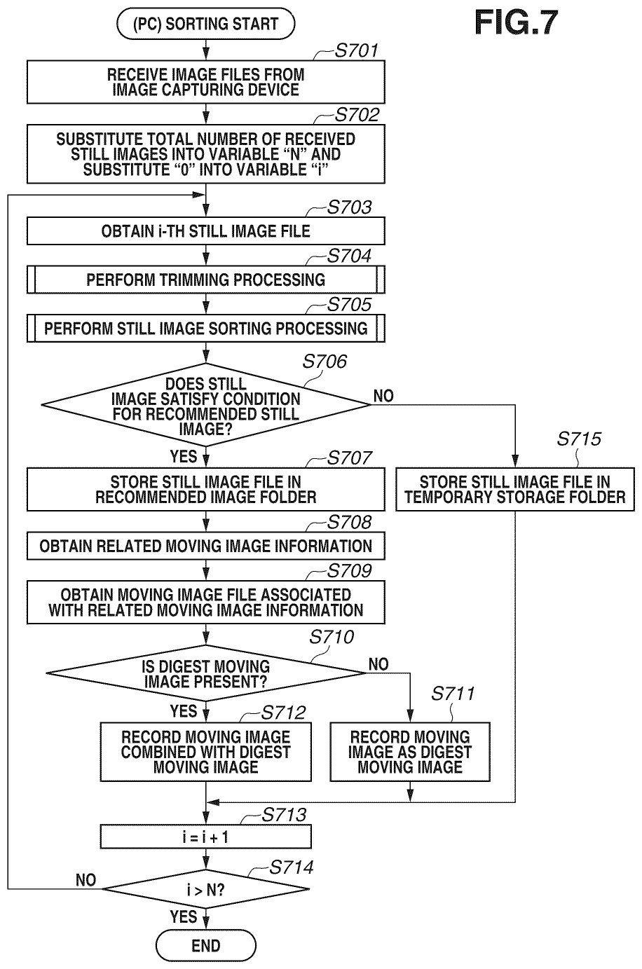

FIG. 7 is a flowchart illustrating details of sorting processing to be performed by the PC 401 that is an example of the information-processing device according to the first exemplary embodiment.

In step S701, the CPU 402 of the PC 401 receives a still image file and a moving image file from the image capturing device 101. The received still image file and moving image file are transferred and copied into the storage device 405 of the PC 401 and are recorded with new file names.

A method for recording a still image file and a moving image file with file names that are different from those in the image capturing device 101 on the hard disk of the PC 401 will now be described with reference to FIGS. 8A to 8D. FIG. 8A illustrates a still image file 801 and a moving image file 802 that are recorded on the memory 215 of the image capturing device 101. FIG. 8B illustrates a still image file 803 and a moving image file 804 that are recorded on the storage device 405 (hard disk) of the PC 401. FIG. 8C illustrates a file structure of a still image file. FIG. 8D illustrates a file structure of a moving image file.

A timestamp “2022/01/10 14:01:56” indicating an image capturing date and time for the still image (image capturing date and time 811 illustrated in FIG. 8C) is stored in the header of the still image file 801 illustrated in FIG. 8A. The still image file 803 illustrated in FIG. 8B is obtained by transferring and copying the still image file 801 illustrated in FIG. 8A into the PC 401. Accordingly, the still image file 801 and the still image file 803 include the same image capturing information and the same still image data. However, in recording the still image file 803 on the hard disk of the PC 401, the CPU 402 generates a new file name “20220110_140156.JPG” from this timestamp. The CPU 402 updates a file name 812 in the header of the still image file 803 with the generated file name.

A timestamp “2022/01/10 14:01:58” indicating an image capturing date and time for the moving image file related to the still image file 801 is also stored to be included in related moving image information 813 in the header of the still image file 801.

The timestamp “2022/01/10 14:01:58” indicating the image capturing date and time (image capturing date and time 821 illustrated in FIG. 8D) at which the moving image is captured is stored in the header of the moving image file 802 illustrated in FIG. 8A. The moving image file 804 illustrated in FIG. 8B is obtained by transferring and copying the moving image file 802 illustrated in FIG. 8A into the PC 401. Accordingly, the moving image file 802 and the moving image file 804 include the same image capturing information and the same moving image data. However, in recording the moving image file on the hard disk of the PC 401, the CPU 402 generates a new file name “20220110_140158.MP4” from this timestamp. The CPU 402 updates a file name 822 in the header of the moving image file 804 with the generated file name.

With this configuration, the moving image file 802 (804) in association with the still image file 801 (803) can be obtained by searching for the moving image file 804 including the file name 822 in the related moving image information 813 in the header of the still image file 803. In particular, the use of a timestamp for a file name makes it possible to prevent a plurality of moving image files from being registered with the same file name. Therefore, it may be desirable to use a timestamp as the related moving image information.

In step S702, the CPU 402 of the PC 401 substitutes the total number of received still images in a variable “N” and substitutes “0” into a variable “i”, as an initial value.

In step S703, the CPU 402 of the PC 401 obtains the i—the still image file.

In step S704, the CPU 402 of the PC 401 performs trimming processing, as appropriate, on the still image in the still image file obtained in step S703. The CPU 402 analyzes the still image in the still image file obtained in step S703, and automatically performs trimming processing depending on the size and position of the subject. Trimming processing for automatically adjusting the angle of view is performed, for example, when the subject in the still image appears smaller, or when the subject is located at an end in the still image.

In step S705, the CPU 402 of the PC 401 executes programs recorded on the ROM 404 or programs such as applications loaded into the RAM 403 from the storage device 405, to perform sorting processing on still images (still images on which trimming processing is performed as appropriate).

This sorting processing is performed to determine whether the still images are images desired by the user. For example, the CPU 402 determines whether an obstacle is present in the still images, whether the still images are similar, or whether the person present as the subject is a child or an adult.

In step S706, the CPU 402 determines whether each still image that is subjected to the sorting processing in step S705 satisfies a condition for a recommended image. If the CPU 402 determines that the still image satisfies the condition for the recommended image (YES in step S706), the processing proceeds to step S707. If the CPU 402 determines that the still image does not satisfy the condition for the recommended image (NO in step S706), the processing proceeds to step S715. In step S715, the CPU 402 performs control processing such that the still image file including the target still image is stored in a temporary storage folder and the temporary storage folder is stored in the storage device 405. Then, the processing proceeds to step S713. Examples of the still image that satisfies the condition for the recommended image include an image in which a child is present as a subject, and an image in which a specific person desired by the user is present.

If the CPU 402 determines that the still image satisfies the condition for the recommended image (YES in step S706), the processing proceeds to step S707. In step S707, the CPU 402 performs control processing such that the still image file including the still image is stored in a recommended image folder and the recommended image folder is stored in the storage device 405.

In step S708, the CPU 402 obtains the related moving image information stored in the header of the still image file including the still image in the recommended image folder. As the related moving image information, information about the moving image, such as a timestamp indicating an image capturing date and time, is obtained.

In step S709, the CPU 402 obtains the moving image file in association with the related moving image information obtained in step S708.

In step S710, the CPU 402 determines whether a digest moving image is already present in the recording medium 221. If the CPU 402 determines that the digest moving image is already present in the recording medium 221 (YES in step S710), the processing proceeds to step S712. If the CPU 402 determines that that the digest moving image is not present in the recording medium 221 (NO in step S710), the processing proceeds to step S711. In step S711, the moving image in the moving image file obtained in step S709 is recorded as the digest moving image on the recording medium 221.

In step S712, the moving image in the moving image file obtained in step S709 is combined after the digest moving image that is already present in the recording medium 221, and the combined moving images are recorded as a single digest moving image on the recording medium 221.

For example, the CPU 402 determines the still image file 803 named “20220110_140156.JPG” illustrated in FIG. 8B to be a recommended image. The moving image file “20220110_140158.MP4” in association with this still image file 803 is used as a digest moving image. The CPU 402 also determines a still image file “20220110_141023.JPG” to be a recommended image. In such a case, a moving image in a moving image file “20220110_141025.MP4” in association with the still image file is combined after the digest moving image (20220110_140158.MP4).

The angle of view when trimming processing is performed in step S704 is recorded, and the trimming processing may be performed on the moving images with the same angle of view when the moving images are combined in step S712.

In step S713, the CPU 402 sets “i” to satisfy i+1, and then the processing proceeds to step S714.

In step S714, the CPU 402 determines whether i>N is satisfied. If the CPU 402 determines that i>N is not satisfied (NO in step S714), the processing returns to step S703. If the CPU 402 determines that i>N is satisfied (YES in step S714), the processing ends.

The user can check the contents of the still image file including the still image that does not satisfy the condition for the recommended image and is stored in the temporary storage folder, and can perform an operation to move the still image file to the recommended image folder or to delete the still image file. The still image file that is selected by the user and is moved to the recommended image folder is hereinafter referred to as a “user selected still image file”.

The CPU 402 obtains related moving image information stored in the header of the user selected still image file, and obtains the moving image file in association with the related moving image information. If the digest moving image based on the recommended image is already generated, the moving image in the moving image file in association with the user selected still image file may be combined before or after the digest moving image, and the combined moving images may be recorded.

If the digest moving image based on the recommended image is already generated, a new digest moving image may be generated by combining only moving images in the moving image files in association with the user selected still image files and the new digest moving image may be record. If no digest moving image based on the recommended image has been generated, the moving image in the moving image file in association with the recommended image and the moving image in the moving image file in association with the user selected still image file may be rearranged in chronological order of an image capturing date and time, and the moving images may be combined to generate a digest moving image to be recorded.

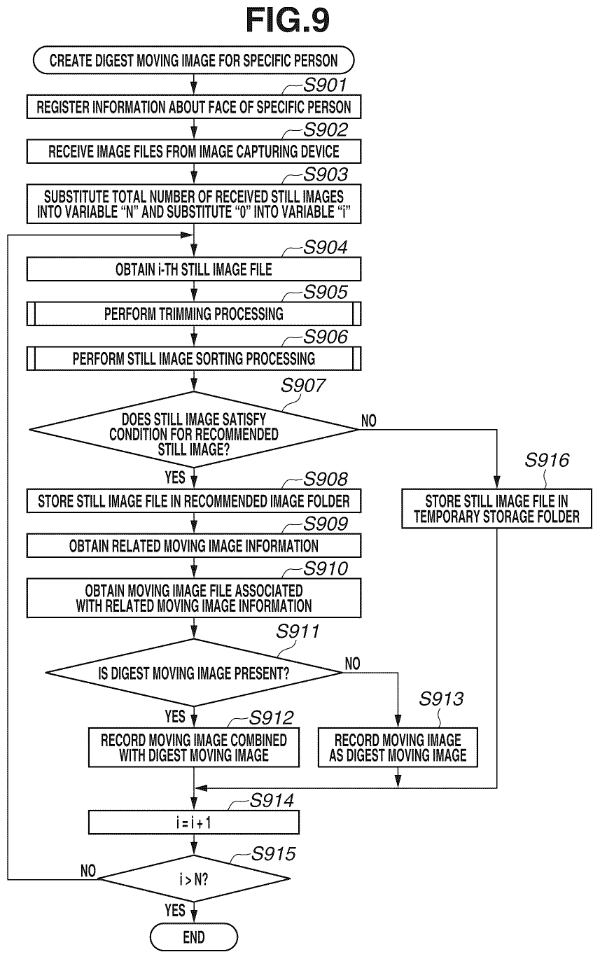

A case where a digest moving image corresponding to still images in which a specific person is present is created instead of using a recommended image will be described with reference to FIG. 9. FIG. 9 is a flowchart illustrating details of the sorting processing in which the PC 401, which is an example of the information-processing device according to the first exemplary embodiment, sorts still images based on whether a specific person is present in the still images.

In step S901, the CPU 402 receives an instruction from the user to register information about the face of a specific person.

The operations in steps S902 to S916 is similar to those in steps S701 to S715 in the flowchart illustrated in FIG. 7. In step S906, the CPU 402 performs image sorting processing not only based on the determination criteria for sorting in the image sorting processing in step S705, but also based on whether the face preliminarily registered in step S901 matches the face of a person present as a subject in the still image. If the preliminarily registered face matches the face of the person present as the subject in the still image, the still image is determined to be a recommended image.

Thus, the PC 401 is used to sort still image files after image capturing, thus making it possible to record the digest moving image including the moving image files in association with the still image files that are sorted out as being desired by the user after image capturing. In other words, the digest moving image excluding moving images in association with still images that are set to be unnecessary as a result of sorting by the user, after image capturing can be automatically generated and recorded.

According to the present exemplary embodiment, moving image files to be used for the digest moving image can be easily identified only by sorting the still image files after image capturing, which leads to a reduction in processing load.

In particular, in a case where the image capturing device 101 automatically captures images, the image capturing device 101 can record a large number of images including the same subject captured with the same angle of view for a long period of time under certain image capturing conditions. If a large number of similar images are recorded, in particular, for similar moving image files, it takes a long time to sort the image files. According to the present exemplary embodiment, the time for sorting the image files can be saved and the digest moving image including no similar scenes can be effectively generated. A method for generating the digest moving image excluding similar scenes is as follows. A certain still image is selected as a recommended image, and then comparison processing is performed to determine whether the still image selected as the recommended image is similar to other still images. The still images similar to the still image selected as the recommended image are not selected as the recommended image. This configuration makes it possible to generate the digest moving image including only moving images in association with a plurality of still images that are not similar to each other, in other words, the digest moving image excluding similar scenes.

A second exemplary embodiment of the present disclosure will be described below. In the first exemplary embodiment, the PC 401 that is an example of the information-processing device is used as the external device for image sorting.

Alternatively, the image capturing device 101 may also perform image sorting processing after image capturing. If the image capturing device 101 also performs image sorting processing after image capturing, a digest moving image including moving image files in association with still image files that are sorted out after image capturing and are desired by the user is recordable. In other words, a digest moving image including no moving images in association with the still images that are sorted by the user after image capturing and are not desired by the user can be recorded. In such a case, automatic image capturing processing to be performed by the image capturing device 101 is similar to the processing in the flowchart illustrated in FIG. 5. If the image capturing device 101 performs image sorting processing, sorting processing in which still image files that are desired by the user are selected as the recommended image after image capturing and still image files that are not desired by the user are deleted is manually performed by the user. The image capturing device 101 automatically performs the processing of obtaining the related moving image information from the still image files selected as the recommended image and combining moving image files in association with the obtained related moving image information.

### Other Embodiments

The above-described various control operations to be performed by the first control unit 223 of the image capturing device 101 and the CPU 402 of the PC 401 may be performed by one hardware module, or by a plurality of hardware modules (e.g., a plurality of processors or circuits) sharing the processing to control the entire device.

The present disclosure has been described in detail above based on the exemplary embodiments. However, the present disclosure is not limited to these specific exemplary embodiments, and can be carried out in various modes without departing from the scope of the present disclosure. The above-described exemplary embodiments are merely exemplary embodiments of the present disclosure and can be combined as appropriate.

The information-processing device according to the present disclosure and the control method for the information-processing device make it possible to generate a digest moving image including moving images corresponding to still images that are sorted out after image capturing and are desired by a user, in the case of recording still images and moving images in association with the still images and combining the recorded moving images to generate one digest moving image.

### Other Embodiments

Embodiment(s) of the present disclosure can also be realized by a computer of a system or apparatus that reads out and executes computer executable instructions (e.g., one or more programs) recorded on a storage medium (which may also be referred to more fully as a ‘non-transitory computer-readable storage medium’) to perform the functions of one or more of the above-described embodiment(s) and/or that includes one or more circuits (e.g., application specific integrated circuit (ASIC)) for performing the functions of one or more of the above-described embodiment(s), and by a method performed by the computer of the system or apparatus by, for example, reading out and executing the computer executable instructions from the storage medium to perform the functions of one or more of the above-described embodiment(s) and/or controlling the one or more circuits to perform the functions of one or more of the above-described embodiment(s). The computer may comprise one or more processors (e.g., central processing unit (CPU), micro processing unit (MPU)) and may include a network of separate computers or separate processors to read out and execute the computer executable instructions. The computer executable instructions may be provided to the computer, for example, from a network or the storage medium. The storage medium may include, for example, one or more of a hard disk, a random-access memory (RAM), a read only memory (ROM), a storage of distributed computing systems, an optical disk (such as a compact disc (CD), digital versatile disc (DVD), or Blu-ray Disc (BD)™), a flash memory device, a memory card, and the like.

While the present disclosure has been described with reference to exemplary embodiments, it is to be understood that the present disclosure is not limited to the disclosed exemplary embodiments. The scope of the following claims is to be accorded the broadest interpretation so as to encompass all such modifications and equivalent structures and functions.

This application claims the benefit of Japanese Patent Application No. 2023-012106, filed Jan. 30, 2023, which is hereby incorporated by reference herein in its entirety.

What is claimed is:

1. An information-processing device comprising:
one or more memories; and
one or more processors in communication with the one or more memories, wherein the one or more processors and the one or more memories are configured to:
record still images, moving images, and information about the moving images in association with the still images on a recording medium;
sort the still images based on whether a predetermined condition is satisfied;
select a still image according to a user instruction from among still images that are sorted out, in the sorting, as not satisfying the predetermined condition;
obtain information about a moving image in association with a still image that is sorted out, in the sorting, as satisfying the predetermined condition and a moving image in association with the selected still image;
obtain, based on the information, the moving image in association with the still image that is sorted out, in the sorting, as satisfying the predetermined condition and the moving image in association with the selected still image; and
generate a single combined moving image by combining a plurality of the moving images in association with the still image that is sorted out, in the sorting, as satisfying the predetermined condition and the selected still image,
wherein the plurality of moving images in association with the still image that is sorted out, in the sorting, as satisfying the predetermined condition and the selected still image is captured within a predetermined period of time at least either before or after capturing of the still images.

2. The information-processing device according to claim 1, wherein the one or more processors and the one or more memories are further configured to:
store, in a first folder, the still image that is sorted out, in the sorting, as satisfying the predetermined condition; and
store, in a second folder, the still images that are sorted, in the sorting, as not satisfying the predetermined condition, the second folder being different from the first folder.

3. The information-processing device according to claim 2, wherein the one or more processors and the one or more memories are configured to perform the selection by transferring the still images stored in the second folder to the first folder according to a user instruction.

4. The information-processing device according to claim 1, wherein, in a case where the selection is performed before the combined moving image is generated, the combined moving image is generated by rearranging the moving image in association with the still image that is sorted out as satisfying the predetermined condition and the moving image in association with the selected still image in chronological order of an image capturing date and time and by combining the rearranged moving images.

5. The information-processing device according to claim 1, wherein, in a case where the selection is performed after the combined moving image is generated, the combined moving image is generated by combining the moving image in association with the selected still image before or after the combined moving image.

6. The information-processing device according to claim 1, wherein, in a case where the selection is performed after the combined moving image is generated, in addition to the combined moving image, a combined moving image is generated by combining the moving image in association with the selected still image.

7. The information-processing device according to claim 1, wherein the still images and the information about the moving images in association with the still images are recorded on a still image file.

8. The information-processing device according to claim 7, wherein the information about the moving images is recorded on a header of the still image file.

9. The information-processing device according to claim 8, wherein the information about the moving images includes at least one of a file name, an identification (ID), and a timestamp for each of the moving images.

10. The information-processing device according to claim 2, wherein in the recording, the still images stored in the first folder and the second folder are recorded on the recording medium.

11. The information-processing device according to claim 1, wherein the one or more processors and the one or more memories are further configured to receive, from an image capturing device, the still images, the moving images, and the information about the moving images in association with the still images.

12. The information-processing device according to claim 1,
wherein the one or more processors and the one or more memories are further configured to perform trimming on the still images based on a size and a position of a subject included in the still images, and
wherein, in the sorting, the trimmed still images are sorted based on a predetermined condition.

13. The information-processing device according to claim 12, wherein the trimming is not performed on the moving images.

14. The information-processing device according to claim 1,
wherein, in a case where an image of a child is included as a subject in the still images, the still images are sorted in the sorting as the still images that satisfy the predetermined condition, and
wherein, in a case where an image of a child is not included as the subject in the still images, the still images are sorted in the sorting as still images that do not satisfy the predetermined condition.

15. The information-processing device according to claim 1,
wherein, in a case where an image of an obstacle is not present in the still images, the still images are sorted in the sorting as still images that satisfy the predetermined condition, and
wherein, in a case where an image of an obstacle is present in the still images, the still images are sorted in the sorting as still images that do not satisfy the predetermined condition.

16. The information-processing device according to claim 1,
wherein the one or more processors and the one or more memories are further configured to detect a face of a person from a still image,
wherein, in a case where the detected face matches a face preliminarily registered in the information-processing device, the still image is sorted in the sorting as a still image that satisfies the predetermined condition, and
wherein, in a case where the detected face does not match the face preliminarily registered in the information-processing device, the still image is sorted in the sorting as still image that does not satisfy the predetermined condition.

17. The information-processing device according to claim 1,
wherein the one or more processors and the one or more memories are further configured to capture an image of a subject, and
wherein, in the recording, still images and moving images obtained in the image capturing are recorded on a recording medium.

18. The information-processing device according to claim 1, wherein, in the selection, the still images recorded on the recording medium are selected according to a manual operation by a user.

19. A method for controlling an information-processing device, the method comprising:
recording still images, moving images, and information about the moving images in association with the still images on a recording medium;
sorting the still images based on whether a predetermined condition is satisfied;
selecting a still image according to a user instruction from among still images that are sorted out, in the sorting, as not satisfying the predetermined condition;
obtaining, as first obtaining, information about a moving image in association with a still image that is sorted out, in the sorting, as satisfying the predetermined condition and a moving image in association with the selected still image;
obtaining, as second obtaining, based on the information obtained in the first obtaining, the moving image in association with the still image that is sorted out, in the sorting, as satisfying the predetermined condition and the moving image in association with the selected still image; and
generating a single combined moving image by combining a plurality of the moving images obtained in the second obtaining,
wherein the plurality of moving images obtained in the second obtaining is captured within a predetermined period of time at least either before or after capturing of the still images.

20. A non-transitory computer-readable recording medium storing a program that, when executed by a computer, cause the computer to perform a method for controlling the information processing device comprising:
recording still images, moving images, and information about the moving images in association with the still images on a recording medium;
sorting the still images based on whether a predetermined condition is satisfied;
selecting a still image according to a user instruction from among still images that are sorted out, in the sorting, as not satisfying the predetermined condition;
obtaining, as first obtaining, information about a moving image in association with a still image that is sorted out, in the sorting, as satisfying the predetermined condition and a moving image in association with the selected still image;
obtaining, as second obtaining, based on the information obtained in the first obtaining, the moving image in association with the still image that is sorted out, in the sorting, as satisfying the predetermined condition and the moving image in association with the selected still image; and
generating a single combined moving image by combining a plurality of the moving images obtained in the second obtaining,
wherein the plurality of moving images obtained in the second obtaining is captured within a predetermined period of time at least either before or after capturing of the still images.
